(19) United States
(12) Patent Application Publication
(10) Pub. No.: US 2023/0397316 A1
(43) Pub. Date: Dec. 7, 2023

(54) DEVICE OF A LIGHTING TECHNOLOGY NETWORK

(71) Applicant: Tridonic GmbH & Co KG, Dornbirn (AT)

(72) Inventors: Frank Lochmann, Dornbirn (AT); Patrik Yves Koch, Dornbirn (AT); Markus Mayrhofer, Dornbirn (AT); Lukas Simma, Dornbirn (AT); Thomas Zengerle, Dornbirn (AT); Patrick Schnell, Dornbirn (AT)

(73) Assignee: Tridonic GmbH & Co KG, Dornbirn (AT)

(21) Appl. No.: 18/034,124

(22) PCT Filed: Nov. 4, 2021
(86) PCT No.: PCT/EP2021/080583

§ 371 Date: Apr. 27, 2023

(30) Foreign Application Priority Data
Nov. 5, 2020 (EP) 20205839.2

(51) Int. Cl. H05B 47/19; H01Q 1/22; H01Q 1/46; F21K 9/237; F21K 9/66; F21K 9/238

(52) U.S. Cl. CPC H05B 47/19; H01Q 1/2291; H01Q 1/46; F21K 9/237; F21K 9/66; F21K 9/238; F21Y 2115/10

(57) ABSTRACT

A device (1) of a lighting technology network (2) is provided. The device (1) comprises one or more antenna units (102) being configured to communicate in respective preferential directions (103). The device (1) further comprises a processing unit (101). The processing unit (101) is configured to determine, in a commissioning phase of the device (1), an association of each further device (1) of the lighting technology network (2) with a respective preferential direction (103) of a respective one of the antenna units (102) that enables a radio connectivity between the device (1) and the respective further device (1). The processing unit (101) is further configured to communicate, in an operating phase of the device (1), to the further devices (1) using the associated one of the antenna units (102) in the associated preferential direction (103). By communicating to a further device (1) using the associated antenna unit (102) in the associated preferential direction (103), a probability of collisions is reduced in an operation phase of the device (1).

### CROSS REFERENCE TO RELATED APPLICATIONS

The present application is the U.S. national stage application of international application PCT/EP2021/080583 filed Nov. 4, 2021, which international application was published on May 12, 2022 as International Publication WO 2022/096546A1. The international application claims priority to European Patent Application No. 20205839.2 filed Nov. 5, 2020.

### TECHNICAL FIELD OF THE INVENTION

The present invention relates to a device of a lighting technology network, and in particular to wireless radio communication among such devices.

### BACKGROUND OF THE INVENTION

In a lighting technology network, devices may communicate amongst each other using various communication technologies, such as wireless radio communication. In view of a sheer number of such devices in some lighting technology networks, wireless radio communication may seriously be affected by collisions, even though the devices may attempt to avoid them by beginning transmission only after a wireless radio channel is sensed to be “idle”.

### SUMMARY OF THE INVENTION

The object of the present invention is to provide a device that improves a wireless radio communication to further such devices of a lighting technology network.

The invention is defined by the appended independent claims. Preferred embodiments are set forth in the dependent claims and in the following description and drawings.

According to a first aspect, a device of a lighting technology network is provided. The device comprises one or more antenna units being configured to communicate in respective preferential directions; and a processing unit. The processing unit is configured to determine, in a commissioning phase of the device, an association of each further device of the lighting technology network with a respective preferential direction of a respective one of the antenna units that enables a radio connectivity between the device and the respective further device. The processing unit is further configured to communicate, in an operating phase of the device, to the further devices using the associated one of the antenna units in the associated preferential direction.

Preferably, in the commissioning phase the device is configured to serve communication setup purposes in the lighting technology network.

Preferably, in the operating phase the device is configured to serve lighting control purposes in the lighting technology network.

Preferably, the one or more antenna units comprise an antenna being configured to communicate in a fixed preferential direction.

Preferably, the one or more antenna units comprise a phased antenna array being configured to communicate in an adjustable preferential direction.

Preferably, the processing unit is configured to determine the association of each further device of the lighting technology network with the respective preferential direction of the respective one of the antenna units by forming a lookup table.

Preferably, the processing unit is configured to determine the association of each further device of the lighting technology network with the respective preferential direction of the respective one of the antenna units by forming a map of a radio environment of the device.

Preferably, the processing unit is configured to determine the association of each further device of the lighting technology network with the respective preferential direction of the respective one of the antenna units that enables a best possible radio connectivity between the device and the respective further device.

Preferably, the best possible radio connectivity is determined in accordance with an analog or digital figure of merit of the radio connectivity.

Preferably, the device comprises a luminaire, a sensor and/or an actuator.

Preferably, the luminaire comprises an LED.

Preferably, the actuator comprises a shade.

According to a second aspect, a method of operating a device of a lighting technology network is provided, the device comprising: one or more antenna units being configured to communicate in respective preferential directions; and a processing unit. The method comprises: determining, by the processing unit and in a commissioning phase of the device, an association of each further device of the lighting technology network with a respective preferential direction of a respective one of the antenna units that enables a radio connectivity between the device and the respective further device; and communicating, by the processing unit and in an operating phase of the device, to the further devices using the associated one of the antenna units in the associated preferential direction.

### BRIEF DESCRIPTION OF THE DRAWINGS

Further aspects, advantages and objects of the invention will become evident for the skilled reader by means of the following detailed description of the embodiments of the invention, when taking into conjunction with the figures of the enclosed drawings.

FIG. 1 illustrates a device of a lighting technology network according to an embodiment of the present invention;

FIG. 2 illustrates a lighting technology network comprising a plurality of devices of FIG. 1;

FIG. 3 illustrates a lookup table of the device of FIG. 1; and

FIG. 4 illustrates a map of a radio environment of the device of FIG. 1.

FIG. 5 illustrates an aerial view of an exemplary radio environment of the device of FIG. 1.

FIG. 6 illustrates a flow chart of a method of operating the device 1 of FIG. 1.

### DETAILED DESCRIPTION OF THE PREFERRED EMBODIMENT

The invention will now be described with respect to various embodiments. The features of these embodiments may be combined with each other unless specified otherwise.

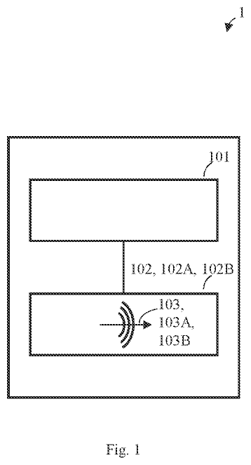

FIG. 1 illustrates a device 1 of a lighting technology network 2 according to an embodiment of the present disclosure;

As used herein, the term “lighting technology network” may refer to a plurality of lighting technology devices being configured to communicate with one another. For example, environmental information may be sensed by a first device, such as a sensor, be communicated to and processed by a second device, such as a controller, and communicated to a third device for actuation of some mechanism in the environment.

The device 1 comprises a processing unit 101, such as a microcontroller, and one or more antenna units 102.

As used herein, the term “antenna unit” may refer to one or more antennas being configured to interface between radio waves propagating through space and electric currents moving in metal conductors, used with a transmitter or receiver. Depending on its structure and/or feed, an antenna unit may or may not have a preferential direction of transmission and/or reception. For example, an antenna unit may include components such as reflectors or parasitic elements which serve to statically direct the radio waves into a beam or other desired radiation pattern. As a further example, a phased antenna array whose antennas are fed with a controllable phase delay to one another may serve to direct the radio waves in an adjustable preferential direction.

Preferably, the device 1 comprises a luminaire, a sensor and/or an actuator, such as shades, for example.

As used herein, the term “luminaire” may refer to a complete lighting unit comprising one or more luminous elements and all other necessary elements and wiring.

As used herein, the term “sensor” may refer to a device being configured to detect events or changes in its environment and to send this information to a further device, such as a control device.

As used herein, the term “actuator” may refer to a device being configured to actuate a mechanism or system in its environment in response to receiving corresponding instructions/information from a further device, such as the afore-mentioned control device.

Preferably, the luminaire comprises an LED.

The one or more antenna units 102 are configured to communicate in respective preferential directions 103. That is to say, each of the one or more antenna units 102 has a respective preferential direction 103 of transmission and reception.

The device 1 may be deployed in a lighting technology network 2 comprising further such devices 1.

In a commissioning phase, the device 1 is preferably configured to serve communication setup purposes in the lighting technology network 2.

Therefore, the processing unit 101 is configured to determine, in the commissioning phase of the device 1, an association of each further device 1 of the lighting technology network 2 with a respective preferential direction 103 of a respective one of the antenna units 102 that enables a radio connectivity between the device 1 and the respective further device 1. For example, the processing unit 101 may passively scan and/or actively prompt its radio environment for any such further device 1 using the one or more antenna units 102 one after another.

In an operating phase, the device 1 is preferably configured to serve lighting control purposes in the lighting technology network 2. It will be appreciated that communication in respect of lighting control requires some level of reliability.

As such, the processing unit 101 is further configured to communicate, in the operating phase of the device 1, to the further devices 1 using the associated antenna unit 102 in the associated preferential direction 103.

By communicating to a further device 1 using the associated antenna unit 102 in the associated preferential direction 103, a directionality of the associated antenna unit 102 is used to reduce a probability of collisions in an operation phase of the device 1.

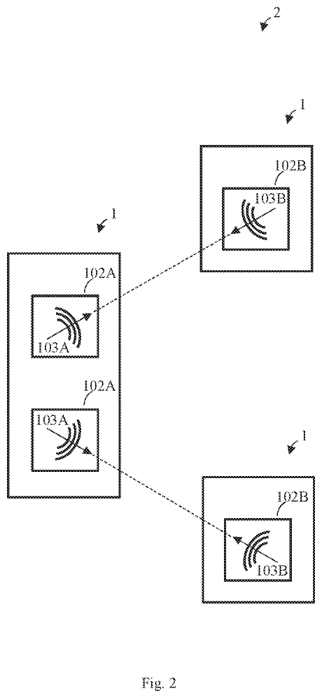

FIG. 2 illustrates a lighting technology network 2 comprising a plurality of devices 1 of FIG. 1.

To the left of FIG. 2 shows a device 1 having a plurality of antenna units 102 that are configured to communicate in a respective fixed preferential direction 103A. Only two such antenna units 102 are shown in the interest of better understanding. For example, the two illustrated antenna units 102 may be those of the one or more antenna units 102 which effectively enable a radio connectivity between the device 1 and the respective further device 1, while others of the one or more antenna units 102 did not enable such a radio connectivity.

To the right of FIG. 2, a plurality of devices 1 are shown having a single antenna unit 102 per each. The respective antenna unit 102 comprises a phased antenna array 102B that is configured to communicate in an adjustable preferential direction 103B. More specifically, each antenna of the phased antenna array 102B transmits/receives a slightly phased (i.e., delayed) copy of a same signal. In connection with a linear arrangement direction of the phased antenna array 102B, the phase/delay between the signals of adjacent antennas defines the preferential direction 103B. The preferential direction 103B may be adjusted by variation of the phase/delay between the signals of adjacent antennas.

With continued reference to FIG. 2, the device 1 to the left of FIG. 2 and the (further) device 1 to the upper right of FIG. 2 comprise antenna units 102A, 102B having matching preferential directions 103A, 103B. Likewise, the device 1 to the left of FIG. 2 and the (further) device 1 to the lower right of FIG. 2 comprise antenna units 102A, 102B having matching preferential directions 103A, 103B, too.

Evidently, in a lighting technology network 2 comprising a plurality of devices 1, there may be times when more than one of the antenna units 102 of the respective device 1 enables a radio connectivity to the respective further device 1. For example, when a particular further device 1 is arranged in between the respective fixed preferential directions 103B of two antenna units 102 of the device 1, as seen by the device 1.

In such cases, the processing unit 101 is preferably configured to determine the association of each further device 1 of the lighting technology network 2 with the respective preferential direction 103, 103A, 103B of the respective one of the antenna units 102 that enables a best possible radio connectivity between the device 1 and the respective further device 1.

Preferably, the best possible radio connectivity is determined in accordance with an analog or digital figure of merit of the radio connectivity. For example, signals received via different antenna units 102 may be compared based on a Signal to Noise Ratio (SNR) as an analog figure of merit, or based on a Bit Error Ratio (BER) as a digital figure of merit.

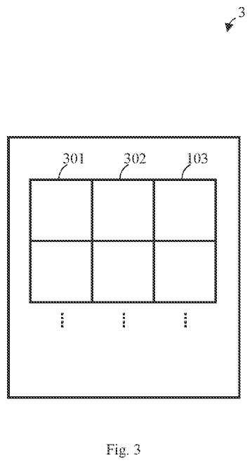

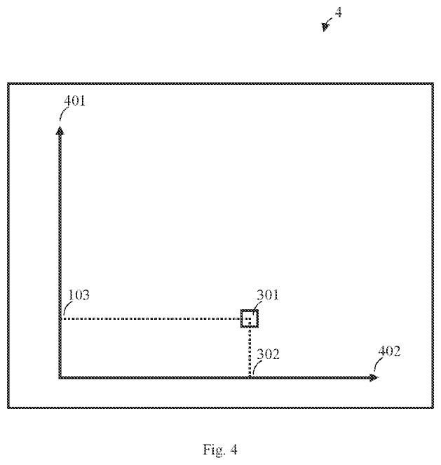

FIGS. 3-4 illustrate alternative embodiments of the present disclosure in respect of associations of further devices 1 with respective antenna units 102 and respective preferential directions 103.

As previously explained, the processing unit 101 of the device 1 is configured to determine the association of each further device 1 of the lighting technology network 2 with the respective preferential direction 103 of the respective one of the antenna units 102. In other words, having determined the associations, the device 1 knows that it may communicate with a particular further device 1 when using the respective associated antenna unit 102 in the respective preferential direction 103.

According to FIG. 3, the processing unit 101 is preferably configured to determine the associations by forming a lookup table 3. FIG. 3 shows one possible implementation of such a lookup table 3, in which each entry (i.e., row) comprises an identifier 301 of the respective further device 1, an identifier 302 of the antenna unit 102 of this further device 1, and the respective preferential direction 103 of this antenna unit 102. In case of fixed preferential directions 103A, a dummy value may be stored. In case of adjustable preferential directions 103A, there may be different entries in a lookup table 3 pertaining to different further devices 1 that involve different preferential directions 103B of a same antenna unit 102B that is configured to communicate in an adjustable preferential direction 103B.

According to FIG. 4, the processing unit 101 is preferably configured to determine the associations by forming a map of a radio environment of the device 1. One possible implementation may comprise a two-dimensional map defined by the identifier 302 of the antenna unit 102 in a first dimension and the preferential direction 103 of this antenna unit 102 in a second dimension. The identifier 301 (and a figure of merit of the underlying radio connectivity, if applicable) of the respective further device 1 may be recorded/mapped where the identifier 302 of the antenna unit 102 and its preferential direction 103 in respect of the particular further device 1 meet.

Besides the embodiments of FIGS. 3 and 4, other kinds of associations are conceivable. For example, the processing unit 101 of a device 1 may be configured to generate one or more “heat” maps of its one-dimensional (e.g., horizontal direction/azimuth) or two-dimensional (e.g., horizontal direction/azimuth, and vertical direction/elevation) environment, wherein a “heat” relates to the afore-mentioned figure of merit of the radio connectivity between the device 1 and the respective further device 1. This may enable determining more than one association of each further device 1 of the lighting technology network 2 with the respective preferential direction 103 of the respective one of the antenna units 102.

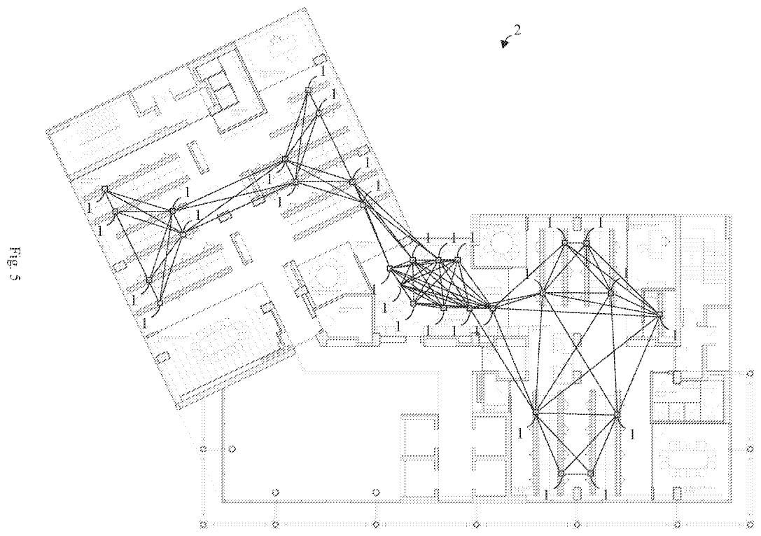

FIG. 5 illustrates an aerial view of an exemplary radio environment of the device 1 of FIG. 1.

The radio environment includes an exemplary building floor plan superimposed with a representation of a lighting technology network 2 formed by a plurality of devices 1 (indicated by small rectangles incorporated in respective luminaires) being interconnected by a plurality of associations (indicated by dashed lines) between pairs of devices 1. Each such association of a device 1 with a further device 1 is determined in a commissioning phase of the device 1 and enables a radio connectivity between said devices 1, thus effectively forming a wireless communication link between them. As such, the lighting technology network 2 may be regarded as a wireless mesh network. The associations of a respective device 1 with further devices 1 may be stored in various ways, such as in a lookup table 3 (see FIG. 3 for an example) of the device 1 or in a map (see FIG. 4 for an example) of the radio environment of the device 1, and in an operating phase the respective device 1 may communicate to the further devices 1 using the respective association (i.e., the associated antenna unit 102 in the associated preferential direction 103).

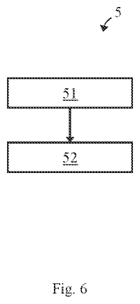

FIG. 6 illustrates a flow chart of a method of operating the device 1 of FIG. 1.

The device 1 comprises: one or more antenna units 102 being configured to communicate in respective preferential directions 103; and a processing unit 101.

The method 5 comprises a step of determining 51, by the processing unit 101 and in a commissioning phase of the device 1, an association of each further device 1 of the lighting technology network 2 with a respective preferential direction 103 of a respective one of the antenna units 102 that enables a radio connectivity between the device 1 and the respective further device 1.

The method 5 further comprises a step of communicating 52, by the processing unit 101 and in an operating phase of the device 1, to the further devices 1 using the associated one of the antenna units 102 in the associated preferential direction 103.

1. A device (1) of a lighting technology network (2), comprising
one or more antenna units (102) being configured to communicate in respective preferential directions (103);
a processing unit (101) being configured to
determine, in a commissioning phase of the device (1), an association of each further device (1) of the lighting technology network (2) with a respective preferential direction (103) of a respective one of the antenna units (102) that enables a radio connectivity between the device (1) and the respective further device (1); and
communicate, in an operating phase of the device (1), to the further devices (1) using the associated one of the antenna units (102) in the associated preferential direction (103).

2. The device (1) of claim 1, wherein in the commissioning phase the device (1) is configured to serve communication setup purposes in the lighting technology network (2).

3. The device (1) of claim 1, wherein in the operating phase the device (1) is configured to serve lighting control purposes in the lighting technology network (2).

4. The device (1) of claim 1, wherein the one or more antenna units (102) comprise an antenna (102A) being configured to communicate in a fixed preferential direction (103A).

5. The device (1) of claim 1, wherein the one or more antenna units (102) comprise a phased antenna array (102B) being configured to communicate in an adjustable preferential direction (103B).

6. The device (1) of claim 1, wherein the processing unit (101) is configured to determine the association of each further device (1) of the lighting technology network (2) with the respective preferential direction (103, 103A, 103B) of the respective one of the antenna units (102, 102A, 102B) by forming a lookup table (3).

7. The device (1) of claim 1, wherein the processing unit (101) is configured to determine the association of each further device (1) of the lighting technology network (2) with the respective preferential direction (103, 103A, 103B) of the respective one of the antenna units (102, 102A, 102B) by forming a map of a radio environment of the device (1).

8. The device (1) of claim 1, wherein the processing unit (101) is configured to determine the association of each further device (1) of the lighting technology network (2) with the respective preferential direction (103, 103A, 103B) of the respective one of the antenna units (102, 102A, 102B) that enables a best possible radio connectivity between the device (1) and the respective further device (1).

9. The device (1) of claim 8, wherein the best possible radio connectivity is determined in accordance with an analog or digital figure of merit of the radio connectivity.

10. The device (1) of claim 1, wherein the device (1) comprises a luminaire, a sensor and/or an actuator.

11. The device (1) of claim 10, wherein the luminaire comprises an LED.

12. The device (1) of claim 10, wherein the actuator comprises a shade.

13. A method (5) of operating a device (1) of a lighting technology network (2),
the device (1) comprising one or more antenna units (102) being configured to communicate in respective preferential directions (103); and a processing unit (101);
the method (5) comprising:
determining (51), by the processing unit (101) and in a commissioning phase of the device (1), an association of each further device (1) of the lighting technology network (2) with a respective preferential direction (103) of a respective one of the antenna units (102) that enables a radio connectivity between the device (1) and the respective further device (1); and
communicating (52), by the processing unit (101) and in an operating phase of the device (1), to the further devices (1) using the associated one of the antenna units (102) in the associated preferential direction (103).
